(19) United States
(12) Patent Application Publication
(10) Pub. No.: US 2024/0038417 A1
(43) Pub. Date: Feb. 1, 2024

(54) Cable and Combined Cable

(71) Applicant: Tyco Electronics (Shanghai) Co., Ltd., Shanghai (CN)

(72) Inventors: Hainan (Harlan) Lu, Dongguan (CN); Zhiwei (Jack) Guo, Dongguan (CN)

(73) Assignee: Tyco Electronics (Shanghai) Co., Ltd., Shanghai (CN)

(21) Appl. No.: 18/361,245

(22) Filed: Jul. 28, 2023

(30) Foreign Application Priority Data
Jul. 29, 2022 (CN) 202210907148.8

(51) Int. Cl. H01B 11/18; H01B 11/06; H01B 11/00; H01B 7/02; H01B 7/00

(52) U.S. Cl. CPC H01B 11/1847; H01B 11/06; H01B 11/002; H01B 7/0208; H01B 7/0009

(57) ABSTRACT

A cable includes a pair of insulation core wires, a shielding layer and an air accommodating cavity. The pair of insulation core wires extend longitudinally parallel to each other. Each of the insulation core wires has a central conductor and a core wire insulation layer wrapped around the central conductor. The shielding layer is wrapped outside the pair of insulation core wires. The air accommodating cavity is formed between the core wire insulation layers of the pair of insulation core wires and the shielding layer, and is adapted to accommodate air.

### CROSS-REFERENCE TO RELATED APPLICATIONS

This application claims the benefit of Chinese Patent Application No. CN 202210907148.8 filed on Jul. 29, 2022, in the China National Intellectual Property Administration, the whole disclosure of which is incorporated herein by reference.

### FIELD OF THE INVENTION

Embodiments of the present disclosure relate generally to a cable, and more particularly, to a cable, such as a twinaxial cable, that is capable of data transmission at high data transmission rates, and to a combined cable including the abovementioned cable.

### BACKGROUND

A structure of a conventional high-speed data transmission cable, such as a 112 gigabit/second (G or Gbps) cable, mainly includes a pair of insulation core wires, a metal shielding layer (e.g., an aluminum layer or a copper layer) wrapped around the insulation core wires, and one or more insulating tape layers wrapped around the metal shielding layer for the purpose of fixation. However, the high-frequency test bandwidth realized by this conventional structure can only reach about 40 G, and its attenuation performance and size are relatively large.

Improved cable structures are desired.

### SUMMARY

According to an embodiment of the present disclosure, a cable includes a pair of insulation core wires, a shielding layer and an air accommodating cavity. The pair of insulation core wires extend longitudinally parallel to each other. Each of the insulation core wires has a central conductor wrapped with a core wire insulation layer. The shielding layer is wrapped outside of the pair of insulation core wires. The air accommodating cavity is formed between the core wire insulation layers of the pair of insulation core wires and the shielding layer, and is adapted to accommodate air.

### BRIEF DESCRIPTION OF THE DRAWINGS

The invention will now be described by way of example with reference to the accompanying Figures, of which:

FIG. 1 is a cross-sectional view schematically showing a structure of a cable according to an exemplary embodiment of the present disclosure.

FIG. 2 is a cross-sectional view schematically showing a core wire insulation layer of an insulation core wire of the cable shown in FIG. 1.

FIG. 3 is a cross-sectional view schematically showing that the insulation core wire and an insulation tape layer of the cable shown in FIG. 1 are assembled together.

FIG. 4 is a cross-sectional view schematically showing a structure of a cable according to another exemplary embodiment of the present disclosure.

FIG. 5 is a cross-sectional view schematically showing a core wire insulation layer of an insulation core wire of the cable shown in FIG. 4.

FIG. 6 is a cross-sectional view schematically showing that the insulation core wire and an insulation tape layer of the cable shown in FIG. 4 are assembled together.

FIG. 7 is a cross-sectional view schematically showing a structure of a cable according to yet another exemplary embodiment of the present disclosure.

FIG. 8 is a cross-sectional view schematically showing a core wire insulation layer of an insulation core wire of the cable shown in FIG. 7.

FIG. 9 is a cross-sectional view schematically showing that the insulation core wire and an insulation tape layer of the cable shown in FIG. 7 are assembled together.

FIG. 10 is a cross-sectional view schematically showing a structure of a cable according to still another exemplary embodiment of the present disclosure.

FIG. 11 is a cross-sectional view schematically showing a core wire insulation layer of an insulation core wire of the cable shown in FIG. 10.

FIG. 12 is a cross-sectional view schematically showing that the insulation core wire and an insulation tape layer of the cable shown in FIG. 10 are assembled together.

FIG. 13 is a cross-sectional view schematically showing a combined cable according to an exemplary embodiment of the present disclosure.

FIG. 14 is a cross-sectional view schematically showing a combined cable according to another exemplary embodiment of the present disclosure.

FIG. 15 is a cross-sectional view schematically showing a combined cable according to yet another exemplary embodiment of the present disclosure.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a cable includes a pair of insulation core wires extending longitudinally parallel to each other. Each of the insulation core wires has a central conductor and a core wire insulation layer circumferentially wrapped around the central conductor, a shielding layer wrapped outside the pair of insulation core wires, and an air accommodating cavity. The air accommodating cavity is formed between the core wire insulation layers of the pair of insulation core wires and the shielding layer.

According to another embodiment of the present disclosure, a combined cable includes at least two of the above-described cables, a total shielding layer wrapped outside the cables, and a total outer sheath arranged over the combined cable.

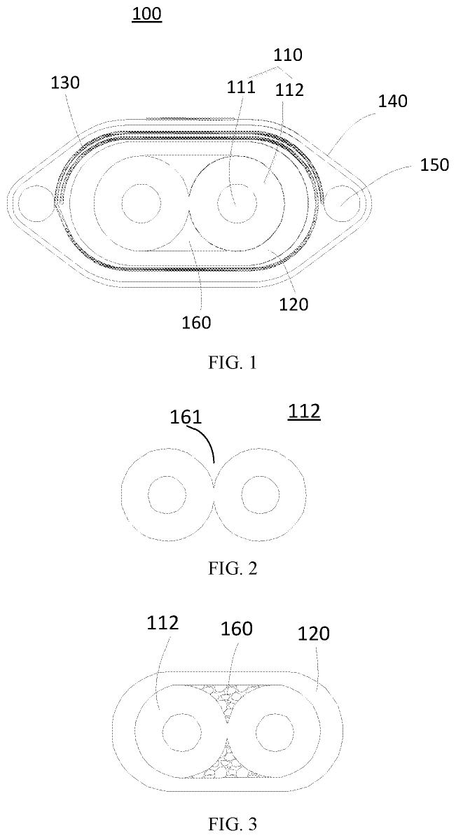

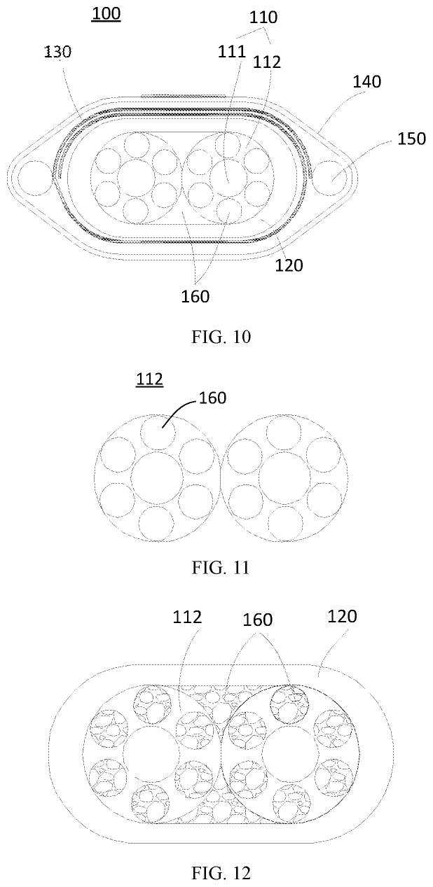

As shown in FIGS. 1-12, embodiments of the present disclosure include cables 100, such as a 112 G cable capable of stable data transmission at high transmission rates (e.g., higher than 60 G). According to a first embodiment, as shown in FIGS. 1-3, the cable 100 according to an embodiment of the present disclosure includes a pair of insulation core wires 110, an insulation tape layer 120 and a shielding layer 130. The pair of insulation core wires 110 are arranged to extend longitudinally parallel to each other. Each of the insulation core wires 110 includes a central conductor 111 and a core wire insulation layer 112 circumferentially wrapped around the central conductor 111. The central conductor 111 may be made of high-conductivity materials such as copper conductors and silver-plated conductors. The core wire insulation layer 112 may be made of insulating material such as polyethylene (PE) or polypropylene (PP). The insulation tape layer 120 may be made of insulating material such as fluorinated ethylene propylene (FEP).

The insulation tape layer 120 is wound outside the core wire insulation layers 112 of the pair of insulation core wires 110 in the longitudinal direction for fixation of the pair of insulation core wires 110. The shielding layer 130 is wrapped outside the insulation tape layer 122, and is configured to shield signals or data transmitted in the insulation core wires 110 from external electromagnetic interference, thus providing an electromagnetic shielding effect. The shielding layer 130 may be made of materials such as copper (Cu)/PP or aluminum (Al)/PP.

In addition, the cable 100 further includes an air accommodating cavity 160 formed between the core wire insulation layers 112 of the pair of insulation core wires 110 and the insulation tape layer 120, and adapted to accommodate air. Thus, the core wire insulation layer 112 includes both the solid material portion and the air accommodating cavity 160. This arrangement reduces an overall dielectric constant of the core wire insulation layer 112, and thus reduces the transmission loss of the coaxial cable 100. It should be understood that in other embodiments of the present disclosure, the cable 100 may have no insulation tape layer 120, in which case the air accommodating cavity 160 is formed between the core wire insulation layer 112 and the shielding layer 130.

As shown in FIGS. 1 and 3, a recess 161 is formed in an outer surface of the core wire insulation layer 112 of the pair of insulation core wires 110. The recess 161 and the insulation tape layer 120 are enclosed to form the air accommodating cavity 160. That is, the recess forms at least a part of the air accommodating cavity 160. In the exemplary embodiment, the core wire insulation layer 112 of each of the insulation core wires 110 has a round ring structure, with the two round ring structures connected together, and the recess 161 is formed by a gap between the two round ring structures. In this embodiment, the two central conductors 111 of the pair of insulation core wires 110 and the core wire insulation layers 112 respectively wrapped around the central conductors are formed in at the same time by a double extrusion process.

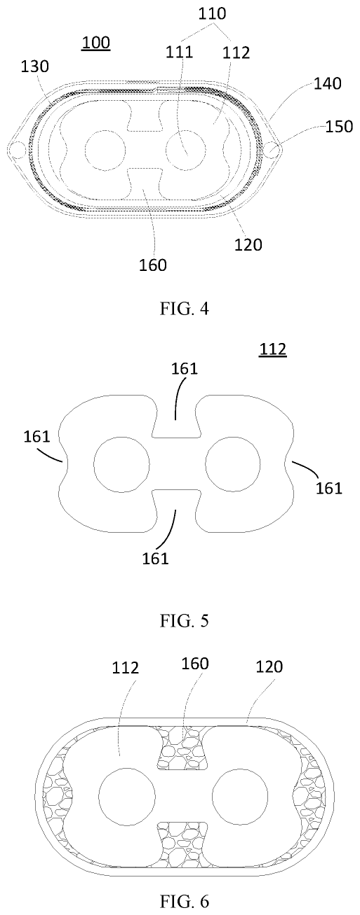

With reference to FIGS. 4-6, a second embodiment of the present disclosure is provided. For the sake of brevity, the same technical features as the first embodiment will not be described, and only the differences between this embodiment and the first embodiment will be described. The number of recesses 161 is four. Two of the recesses 161 are located on radially oppositely outer sides of the pair of insulation core wires 110, respectively, and the other two of the recesses are located between the two central conductors 111 of the pair of insulation core wires 110, respectively.

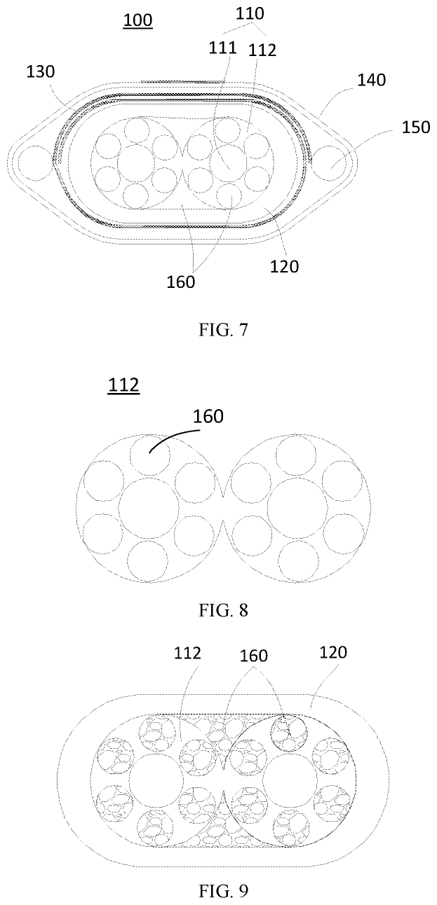

With reference to FIGS. 7-9, a third embodiment of the present disclosure is shown. For the sake of brevity, the same technical features as the first embodiment will not be described, and only the differences between this embodiment and the first embodiment will be described. The air accommodating cavity 160 is further formed inside the core wire insulation layer 112. A plurality of air accommodating cavities 160 are distributed around each of the central conductors 111 at intervals (e.g., equal intervals in a circumferential direction). In this embodiment, the two central conductors 111 of the pair of insulation core wires 110 and the core wire insulation layers 112 respectively wrapped around the central conductors 111 are formed simultaneously by a double extrusion process. The core wire insulation layers 112 of the pair of insulation core wires 110 are made of FEP.

With reference to FIGS. 1, 4, 7 and 10, a fourth embodiment of the present disclosure is provided. For the sake of brevity, the same technical features as the first and third embodiments will not be described, and only the differences between this embodiment and the first and third embodiments will be described. The central conductor 111 of each of the pair of insulation core wires 110 and the core wire insulation layer 112 wrapped around the central conductor 111 are formed simultaneously by a single extrusion process.

The insulation tape layer 120 is wrapped outside the core wire insulation layers 112 of the pair of insulation core wires 110. In this way, the core wire insulation layers 112 of the pair of insulation core wires 110 are deformed under pressure in an radial direction parallel to a line which extends through the centers of the two central conductors 111 of the pair of insulation core wires. As a result, the distance between the centers of the central conductors 111 of the pair of insulation core wires 110 is minimized, thereby reducing the insulation OD, and further increasing the coupling to improve the attenuation.

An inner surface of the shielding layer 130 is provided with hot melt adhesive. The inner surface of the shielding layer 130 refers to the side of the shielding layer facing the insulation core wire 110. In this way, the shielding layer 130 can be bonded to the insulation tape layer 120. The first and second ends of the shielding layer 130 are bonded together, so that the shielding layer forms a closed loop in the circumferential direction.

The cable 100 according to embodiments of the present disclosure further includes an outer sheath 140 circumferentially wrapped around the outer peripheral surface of the shielding layer 130, providing a protection function. The outer sheath 140 can be in the form of a double layer of hot-melt PET (with an inner adhesive side facing inward and an outer adhesive side facing outward) or an extruded sleeve.

The cable 100 further includes a ground wire 150. The ground wire 150 is arranged between the outer sheath 140 and the shielding layer 130 to press the ground wire against the outer peripheral surface of the shielding layer. The cable 100 can include two ground wires 150 located on radially oppositely outer sides of the pair of insulation core wires 110, respectively. In some exemplary embodiments, the cable 100 can also include one ground wire 150 located on an outer side of one insulation core wire 110 in the pair of insulation core wires 110 away from the other insulation core wire of the pair of insulation core wires in the radial direction. A center of the central conductor 111 of the pair of insulation core wires 110 and a center of the ground wire 150 may be located in the same radial plane. The center of the ground wire 150 may be located radially outside the center of the central conductor 111 of the pair of insulation core wires 110.

In some exemplary embodiments, the shielding layer 130 may be configured for electrical connection to an external ground, and the cable 100 has no separate ground wire. In other words, the shielding layer 130 concurrently serves as the ground wire, thus providing a cable with a more structured outer profile.

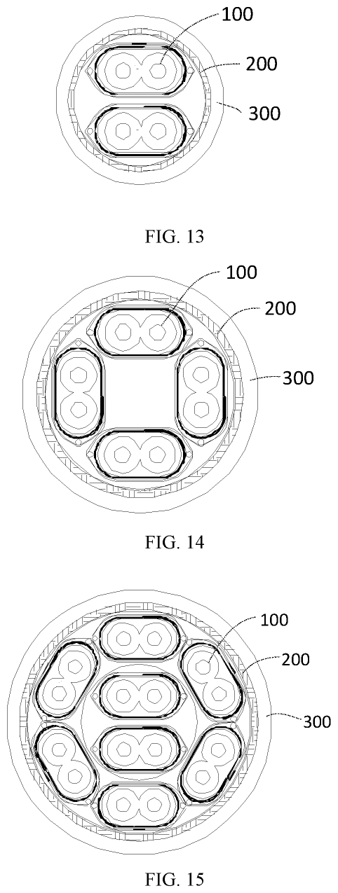

According to another aspect of the present disclosure, as shown in FIG. 13-15, a combined cable includes at least two cables 100, a total shielding layer 200 wrapped outside the cables, and a total outer sheath 300 located at the outermost of the combined cable. The cables 100 are radially and symmetrically distributed with respect to the center of the combined cable. Specifically, in the embodiment shown in FIG. 13 there are two cables 100. In the embodiment shown in FIG. 14 there are four cables 100. In the embodiment shown in FIG. 15 there are eight cables 100. However, it should be understood that in some other embodiments of the present disclosure, the combined cables may also include six, ten, etc. cables 100, or may also include an odd number of cables, for example three, five, etc.

In the illustrated embodiment, as shown in FIG. 15, the combined cable includes eight cables 100, and two cables of the eight cables are located at the center of the combined cable, and the remaining six cables of the eight cables are distributed evenly in a circular array around the two cables located at the center.

It should be noted that although the cable 100 in the combined cables shown in FIG. 13 to FIG. 15 is the combined cable described in the first embodiment, those skilled in the art should understand that in some other embodiments, the cable of the combined cable can be replaced by the cable described in the second embodiment, the third embodiment or the fourth embodiment without departing from the scope of the present disclosure

According to the cable and the combined cable of the forgoing various embodiments of the present disclosure, the cable includes the air accommodating cavity for accommodating air. In this way, the core wire insulation layer includes both the solid material portion and the air accommodating cavity for accommodating air. This arrangement reduces an overall dielectric constant of the core wire insulation layer, and thus reduces the transmission loss of the coaxial cable. Furthermore, the insulation tape layer is wrapped around the core wire insulation layers of the pair of insulation core wires. The core wire insulation layers of the pair of insulation core wires are deformed under pressure in a radial direction parallel to a line which goes through the centers of the two central conductors of the pair of insulation core wires. As a result, the distance between the centers of the central conductors of the pair of insulation core wires is minimized, thereby reducing the insulation OD, and further increasing the coupling to improve the attenuation. In addition, the cable has a higher transmission bandwidth, which can reach 60 G or higher in frequency, and the cable is flexible and small in size.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A cable, comprising:
a pair of insulation core wires extending longitudinally parallel to each other, each of the insulation core wires having a central conductor and a core wire insulation layer wrapped around the central conductor;
a shielding layer wrapped outside of the pair of insulation core wires; and
an air accommodating cavity formed between the core wire insulation layers of the pair of insulation core wires and the shielding layer, and accommodating air.

2. The cable according to claim 1, further comprising an insulation tape layer wrapped outside of the core wire insulation layers of the pair of insulation core wires and fixing a position the pair of insulation core wires, the air accommodating cavity is formed between the core wire insulation layers of the pair of insulation core wires and the insulation tape layer.

3. The cable according to claim 1, wherein a recess is formed in an outer surface of the core wire insulation layer of the pair of insulation core wires to define at least a part of the air accommodating cavity.

4. The cable according to claim 3, wherein the core wire insulation layer of each of the insulation core wires has a round ring structure, and the recess is formed by a gap between the two round ring structures.

5. The cable according to claim 3, wherein the number of the recesses is four, two of the recesses are located on radially oppositely outer sides of the pair of insulation core wires, respectively, and the other two of the recesses are located between the two central conductors of the pair of insulation core wires, respectively.

6. The cable according to claim 4, wherein the two central conductors of the pair of insulation core wires and the core wire insulation layers respectively wrapped around the central conductors are formed contemporaneously by a double extrusion process.

7. The cable according to claim 3, wherein the core wire insulation layer is made of polyethylene or polypropylene.

8. The cable according to claim 3, wherein the air accommodating cavity is further formed inside the core wire insulation layer.

9. The cable according to claim 8, wherein a plurality of the air accommodating cavities are distributed around each of the central conductors.

10. The cable according to claim 9, wherein the two central conductors of the pair of insulation core wires and the core wire insulation layers respectively wrapped around the central conductors are formed contemporaneously by a double extrusion process.

11. The cable according to claim 9, wherein the central conductor of each of the pair of insulation core wires and the core wire insulation layer wrapped around the central conductor are formed contemporaneously by a single extrusion process.

12. The cable according to claim 8, wherein the core wire insulation layer is made of fluorinated ethylene propylene.

13. The cable according to claim 2, wherein the insulation tape layer is wrapped outside of the core wire insulation layers of the pair of insulation core wires, the insulation tape layer deforming the core wire insulation layers of the pair of insulation core wires in a radial direction parallel to a line extending through the centers of the two central conductors of the pair of insulation core wires.

14. The cable according to claim 2, wherein the insulation tape layer is made of polytetrafluoroethylene (PFTE).

15. The cable according to claim 1, further comprising an outer sheath wrapped outside of the shielding layer.

16. The cable according to claim 15, further comprising a first ground wire arranged between the outer sheath and the shielding layer and pressed against an outer peripheral surface of the shielding layer.

17. The cable according to claim 16, further comprising a second ground wire, the two ground wires located on respective radially opposite outer sides of the pair of insulation core wires.

18. The cable according to claim 16, wherein the ground wire is located on a side of the core wire insulation layer of one insulation core wire of the pair of insulation core wires away from the other insulation core wire of the pair of insulation core wires in an radial direction.

19. The cable according to claim 1, wherein the shielding layer is adapted to electrically connect to an external ground, and the cable has no separate ground wire.

20. A combined cable, comprising:
at least two cables, each cable including:
a pair of insulation core wires extending longitudinally parallel to each other, each of the insulation core wires having a central conductor and a core wire insulation layer wrapped around the central conductor;
a shielding layer wrapped outside of the pair of insulation core wires; and
an air accommodating cavity formed between the core wire insulation layers of the pair of insulation core wires and the shielding layer;
a total shielding layer wrapped outside of the cables; and
a total outer sheath arranged over the at least two cables.
